(19) United States
(12) Patent Application Publication
(10) Pub. No.: US 2010/0157359 A1
(43) Pub. Date: Jun. 24, 2010

(54) Printer Driver Graphical User Interface

(76) Inventors: Hannah Steiner, Berthoud, CO (US); Xi Zhu, Chongqing (CN)

Correspondence Address: InfoPrint Solutions/ Blakely, 1279 Oakmead Parkway, Sunnyvale, CA, 94085-4040, US

(21) Appl. No.: 12/342,717

(22) Filed: Dec. 23, 2008

(51) Int. Cl. G06F 15/00; G06F 3/048

(52) U.S. Cl. 358/1.15; 715/777

(57) ABSTRACT

A printer driver includes a graphical user interface (GUI) having a plurality of function tabs each associated with a print option function. The function tabs include a quick tab that provides secondary shortcut tabs that enables customized function organization specific to a print job.

### FIELD OF THE INVENTION

The invention relates generally to the field of printing systems. More particularly, the invention relates to printer drivers.

### BACKGROUND

Typically, printing from a computer system occurs through the use of a printer driver. A printer driver is a piece of software that converts data to be printed to a form specific to a printer, which allows an application to perform printing without being aware of the technical details of each printer model. Upon either an application launch or during a print command load time, the application will call an instance of the printer driver and provide the user with a graphical user interface (GUI) to set the desired printer driver settings.

Printing jobs can be time consuming and tedious when a user (or printer operator) is trying to set settings and other variables within the functions for a specific print job. Particularly, many categories of functions may be involved with printing a job, which increases the difficulty in quickly locating necessary functions, resulting in decreased production.

Customization enables efficiency in printing jobs. However, not every printer driver supports customization in the same manner. For example, certain printer drivers can customize tabs by adding and deleting functions from a set list of printer driver functions, while some printer drivers can memorize the variables within the functions and keep those settings until it is changed by an operator. Yet other printer drivers offer pre-made preset profiles for the printer operator to choose from.

However, there are disadvantages to such customization solutions. The customize tab solution is very time consuming and makes it tedious to add and delete functions from the functions list. Further, the printer operator can customize the layout by selecting “move-up” and “move-down” functions within the list. However, the printout resulting from the selection often does not come out the way it was intended. Moreover, there is a quantity limit that defines how many tabs can be placed within the workspace.

The memorization of variables solution does not allow the settings to be saved. Thus, the settings must be changed with each different print job, which results in the slowing down of production. The preset profiles solutions are not intuitive and makes it is difficult to know the specific settings chosen based on a profile name.

Accordingly, a new customization interface is desired in order to expedite the printing process for printer operators in order to provide more flexibility for customization of workspace within a printer driver.

### SUMMARY

In one embodiment, a printer driver includes a GUI having a plurality of function tabs each associated with a print option function. The function tabs include a quick tab that provides secondary shortcut tabs that enables customized function organization specific to a print job.

Another embodiment discloses a computer system including a memory to store a printer driver program a processor coupled to the memory to execute the printer driver program and a display device to display a GUI upon the processor executing the printer driver program. The GUI includes a plurality of function tabs each associated with a print option function, where the function tabs including a quick tab that provides secondary shortcut tabs that enables customized function organization specific to a print job

A further embodiment discloses a GUI comprising a first function tab associated with a first set of print functions, a second function tab associated with a second set of print functions and a quick tab having secondary shortcut tabs that enable customized function organization specific to a print job.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 is a screen shot of one embodiment of a GUI;

FIG. 3 is a screen shot of another embodiment of a GUI;

FIGS. 4A-4E are screen shot of various embodiments of a GUI;

FIG. 5 is a screen shot of yet another embodiment of a GUI; and

FIG. 6 illustrates one embodiment of a computer system.

### DETAILED DESCRIPTION

A customizable print driver GUI is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

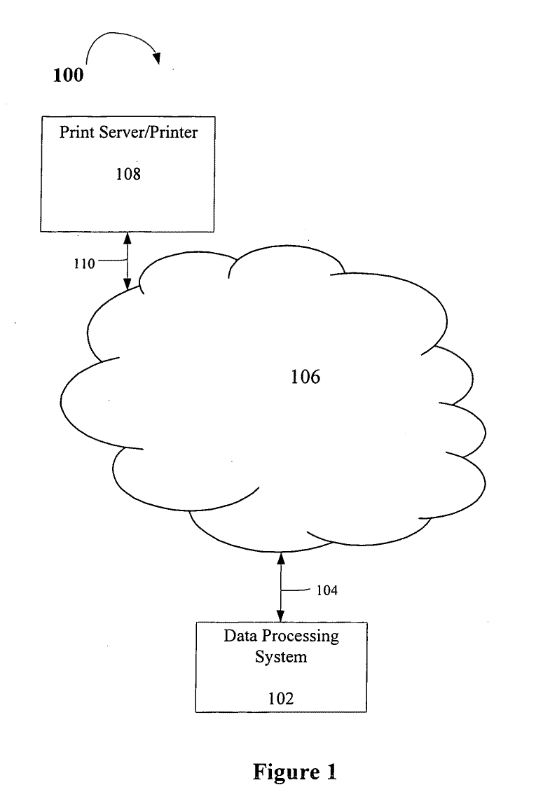

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system or a similar operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server/printer 108 serving print requests over network 106 received via communications link 110 between print server/printer 108 and network 106. The operating system on data processing system 102 is capable of selecting print server/printer 108 and submitting requests for services to print server/printer 108 over network 106. Print server/printer 108 includes a print queue for print jobs requested by remote data processing systems 102. Further, print server/printer 108 includes a control unit 109 to perform operations associated with printing a request.

Although described as incorporated within the same entity, other embodiments may include the print server and the printer as being physically separate components. Therefore, the data processing system network 100 depicted in FIG. 1 is selected for the purposes of explaining and illustrating the present invention and is not intended to imply architectural limitations. Those skilled in the art will recognize that various additional components may be utilized in conjunction with the present invention.

According to one embodiment data processing system 102 implements a printer driver to facilitate the printing of print jobs to print server/printer 108. In a further embodiment, the printer driver includes a double-level tab system GUI that appears on a data processing system 102 display whenever the printer driver is opened.

In one embodiment, the GUI includes a Quick Tab feature that utilizes drag & drop functionality in order to create customized, re-usable, and efficient secondary short-cut tabs that are specific, but not limited, to job requirements for a specific printing job or the desired function organization for a specific printer operator.

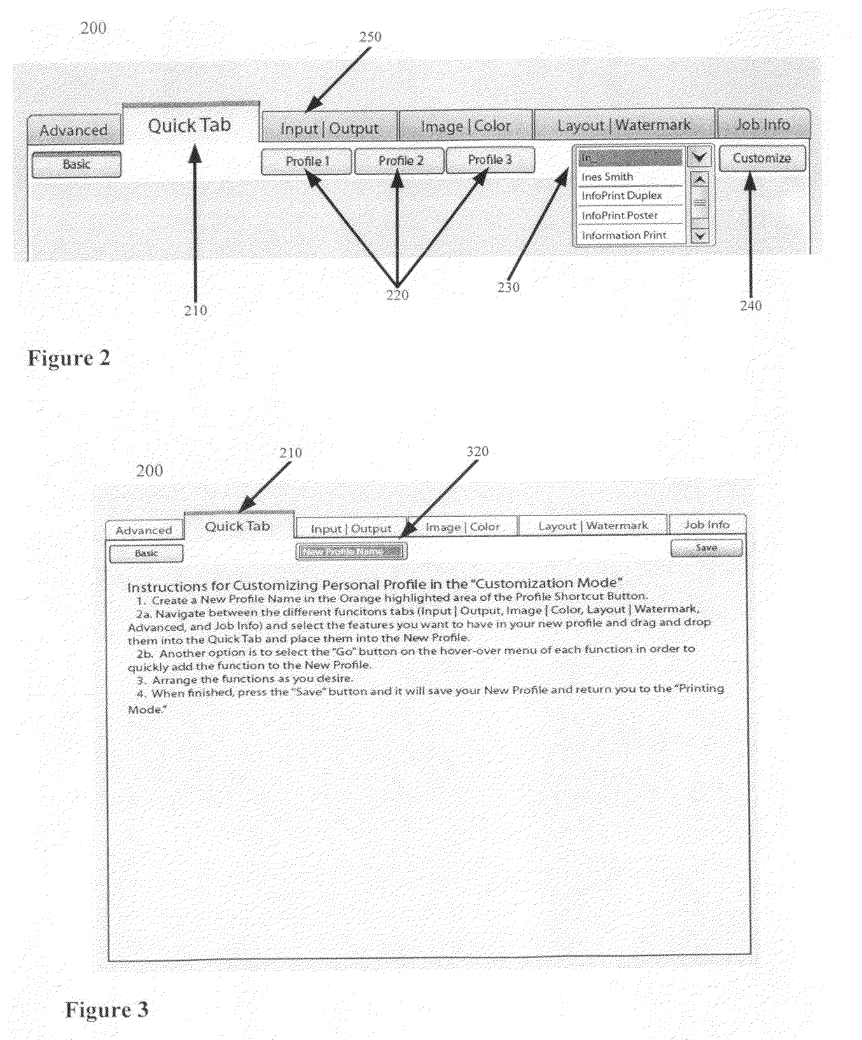

FIG. 2 is a screen shot of one embodiment of a GUI 200 incorporating the Quick Tab. GUI 200 includes first level tabs that represent general function categories. The first level tabs include Quick Tab 210 and Input/Output Tag 250, among others. Upon selection of Quick Tab 210 by a printer operator, second level tabs are displayed.

The second level tabs include a Basic Button, Profile Buttons 220 that represent the last 3 used profiles, a Profile Search Bar 230, and a Customize Button 240. According to one embodiment, each of Profile Buttons 220 represent a predefined profile. In a further embodiment, the three most recently used profiles are displayed as Profile Buttons 220 in the secondary tab under Quick Tab 210. In yet a further embodiment, an operator can select a desired profile from the searchable profile the Profile Search 230 drop-down menu if the second Profile Buttons 220 do not display the desired profile.

Upon selection of Customize Button 240, GUI 200 will enter a Customization Mode. Upon entering the Customization Mode the operator will observe a difference in the driver. FIG. 3 is a screen shot of one embodiment of GUI 200 after entering the Customization Mode. The Customization Mode will bring up a new secondary tab under the Quick Tab with the title prompt 320 highlighted indicating that the operator can rename the profile. Further, there are instructions on this page to the operator as to how to customize the profile workspace. Following the instructions, the operator can go to other function categories and select the specific functions that they need for their own Profile.

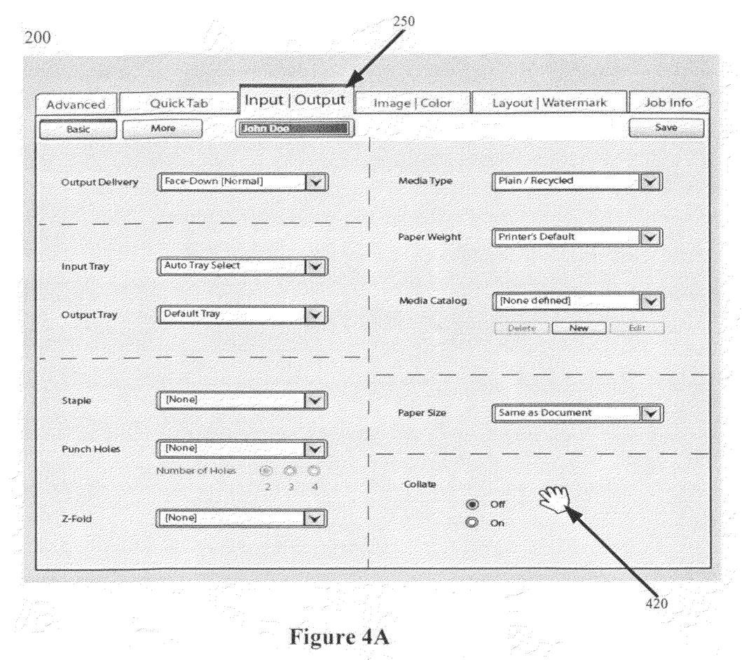

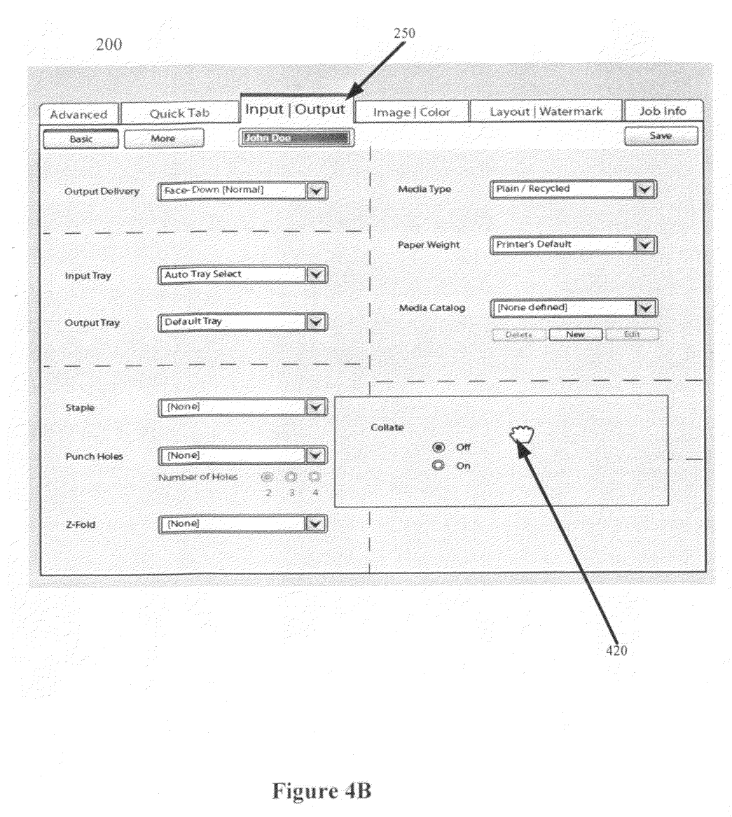

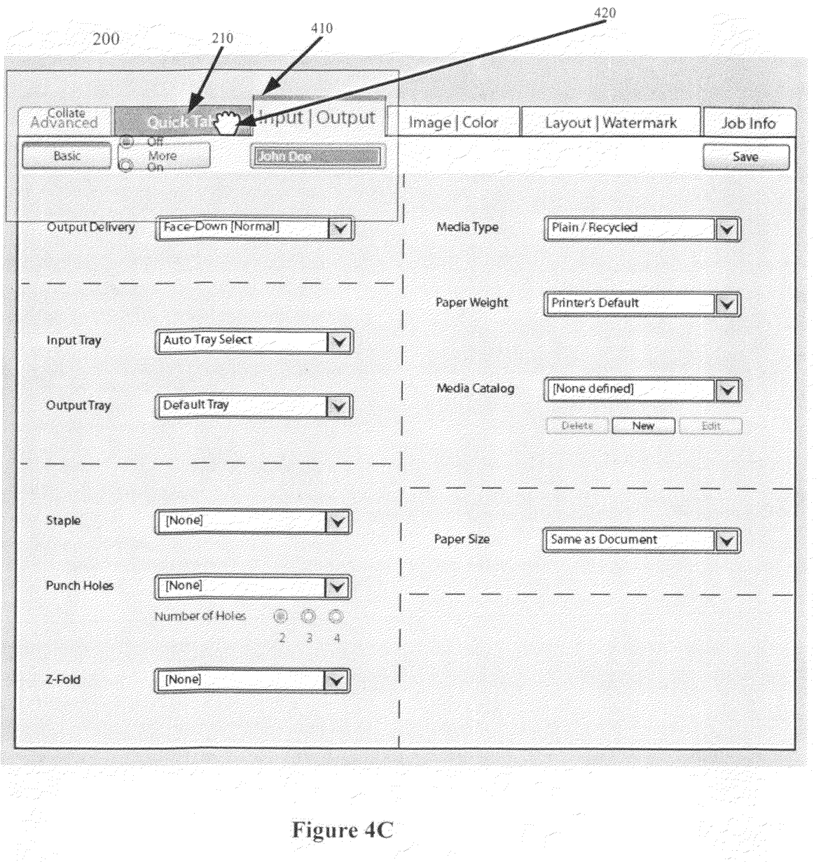

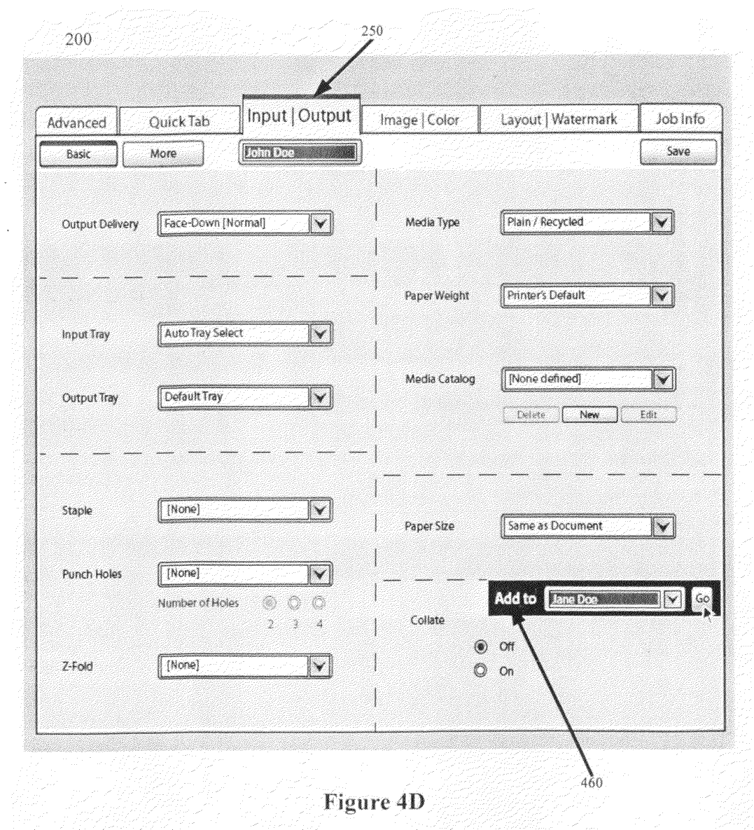

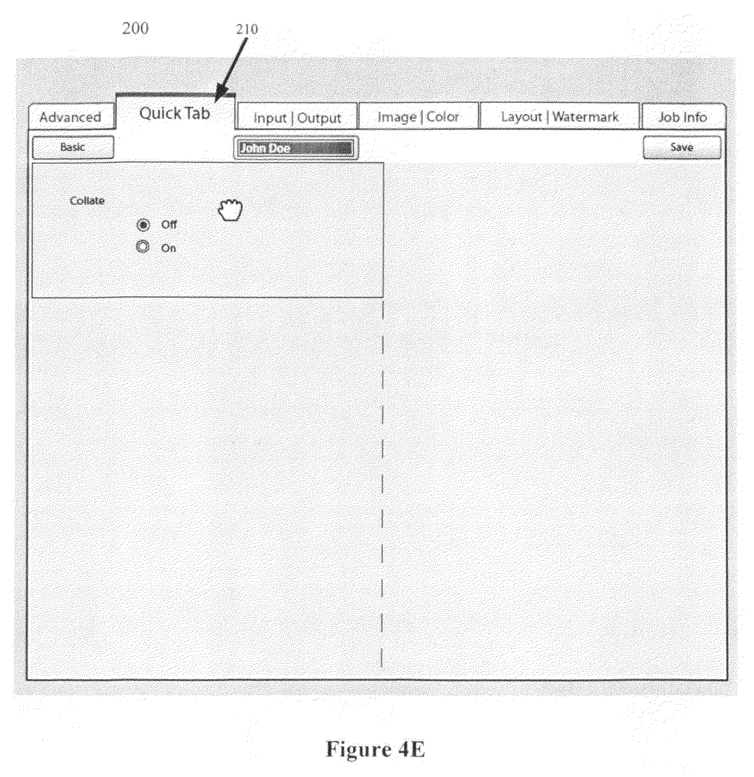

Upon clicking a different function category (such as Input/Output tab 250) after entering the Customization Mode, the operator will observe that the tab has been visually divided by dotted lines. FIG. 4A is a screen shot of one embodiment of GUI 200 after selecting Input/Output tab 250. The boundaries divide the various functions from one another, which enables the operator to grab one of the bounding boxes and drag it into Quick Tab 210.

As shown in FIG. 4A, a first step of cursor hand grabbing a collate function. FIGS. 4B-4C are screen shots of GUI 200 illustrating various stages of using hand cursor 420 to drag the collate function into Quick Tab 210. In addition to the drag and drop customization, the operator may quickly customize their own profile through the use of a hover-over menu.

FIG. 4D is a screen shot of another embodiment of GUI 200 after selecting Input/Output tab 250, where the collate function includes a hover-over menu. When the operator hovers over each boundary box, a shadow menu 460 comes alive once the operator moves hand cursor 420 into the box. According to one embodiment, the operator can use short-cuts within the menu to add functions to their own profile.

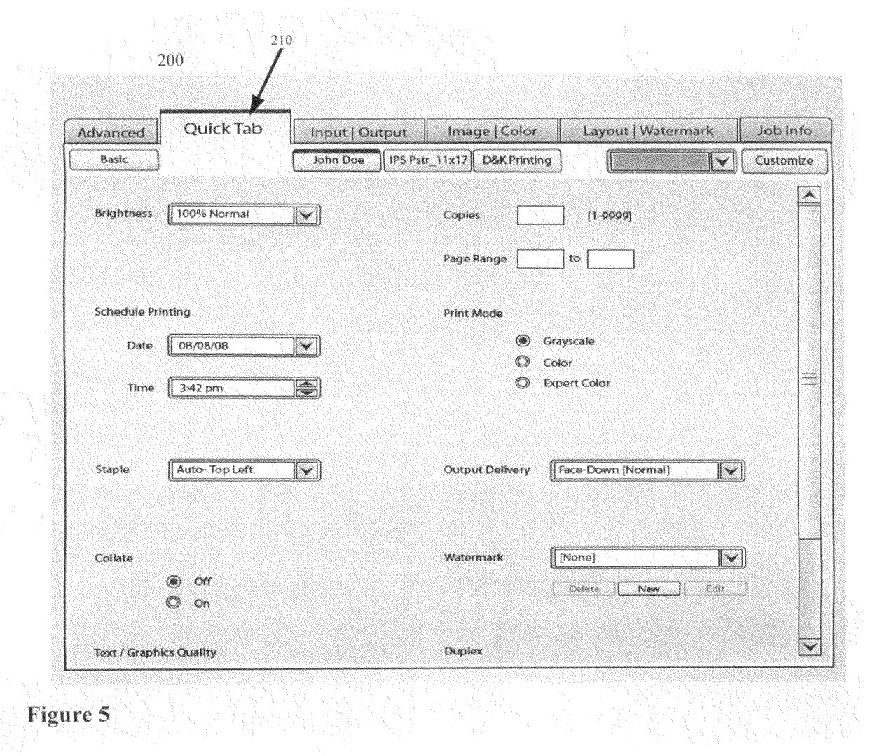

Once the operator has placed all of the desired functions into their own profile, the operator can arrange the functions according to their own preferences. Once finished arranging their profile, the operator can save their individual profile by clicking the “Save” button. FIG. 4E is a screen shot of one embodiment of GUI 200 after the collate function has been dragged into Quick Tab 210. FIG. 5 is a screen shot of one embodiment of a completed customized profile labeled John Doe.

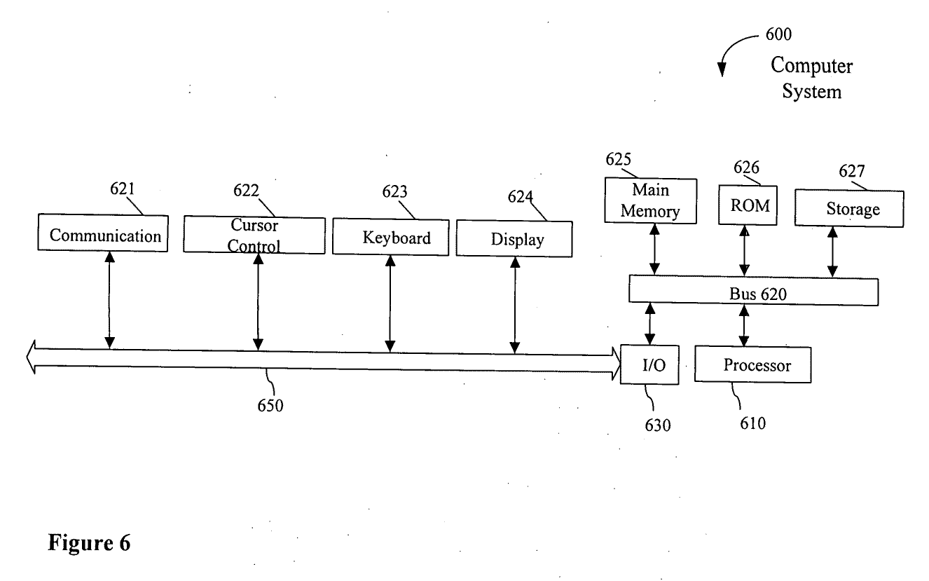

FIG. 6 illustrates a computer system 600 on which data processing system 102 and/or server 108 may be implemented. Computer system 600 includes a system bus 620 for communicating information, and a processor 610 coupled to bus 620 for processing information.

Computer system 600 further comprises a random access memory (RAM) or other dynamic storage device 625 (referred to herein as main memory), coupled to bus 620 for storing information and instructions to be executed by processor 610. Main memory 625 also may be used for storing temporary variables or other intermediate information during execution of instructions by processor 610. Computer system 600 also may include a read only memory (ROM) and or other static storage device 626 coupled to bus 620 for storing static information and instructions used by processor 610.

A data storage device 625 such as a magnetic disk or optical disc and its corresponding drive may also be coupled to computer system 600 for storing information and instructions. Computer system 600 can also be coupled to a second I/O bus 650 via an I/O interface 630. A plurality of I/O devices may be coupled to I/O bus 650, including a display device 624, an input device (e.g., an alphanumeric input device 623 and or a cursor control device 622). The communication device 621 is for accessing other computers (servers or clients). The communication device 621 may comprise a modem, a network interface card, or other well-known interface device, such as those used for coupling to Ethernet, token ring, or other types of networks.

The above-described mechanism provides real-time customization allowing for a user to physically view updates made to a Quick Tab as the changes are being made, thus enabling printer operators to save time and work more efficiently during the printing process.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A printer driver comprising:
a graphical user interface (GUI) having a plurality of function tabs each associated with a print option function, the function tabs including a quick tab that provides secondary shortcut tabs that enables customized function organization specific to a print job.

2. The printer driver of claim 1 wherein the secondary shortcut tabs comprise one or more profile buttons.

3. The printer driver of claim 2 wherein the one or more profile buttons comprise:
a first profile button representing a first print profile having a first customized function organization; and
a second profile button representing a second print profile having a second customized function organization.

4. The printer driver of claim 3 wherein the secondary shortcut tabs further comprise a profile search bar to enable keyword searching for the first and second print profiles.

5. The printer driver of claim 3 wherein the secondary shortcut tabs further comprise a customize button to initiate generation of a new print profile by entering a customization mode.

6. The printer driver of claim 5 wherein the customization mode includes instructions for how to generate the new print profile.

7. The printer driver of claim 6 wherein the new print profile is generated by selecting one or more of the function tabs and selecting one or more functions included in the one or more of the function tabs for inclusion in the new print profile.

8. The printer driver of claim 7 wherein selecting a function comprises dragging a function to the quick tab for inclusion into the new print profile.

9. The printer driver of claim 7 wherein selecting a function comprises choosing a function from a shadow menu.

10. The printer driver of claim 7 wherein the customization mode includes assigning a name for the new print profile.

11. A computer system comprising:
a memory to store a printer driver program;
a processor, coupled to the memory, to execute the printer driver program; and
a display device to display a graphical user interface (GUI) upon the processor executing the printer driver program, the GUI having a plurality of function tabs each associated with a print option function, the function tabs including a quick tab that provides secondary shortcut tabs that enables customized function organization specific to a print job.

12. The computer system of claim 11 wherein the secondary shortcut tabs comprise one or more profile buttons.

13. The computer system of claim 12 wherein the one or more profile buttons comprise:
a first profile button representing a first print profile having a first customized function organization; and
a second profile button representing a second print profile having a second customized function organization.

14. The computer system of claim 13 wherein the secondary shortcut tabs further comprise a profile search bar to enable keyword searching for the first and second print profiles.

15. The computer system of claim 13 wherein the secondary shortcut tabs further comprise a customize button to initiate generation of a new print profile by entering a customization mode.

16. The computer system of claim 15 wherein the new print profile is generated by selecting one or more of the function tabs and selecting one or more functions included in the one or more of the function tabs for inclusion in the new print profile.

17. The computer system of claim 15 wherein selecting a function comprises dragging a function to the quick tab for inclusion into the new print profile.

18. The computer system of claim 15 wherein selecting a function comprises choosing a function from a shadow menu.

19. A graphical user interface (GUI) comprising:
a first function tab associated with a first set of print functions;
a second function tab associated with a second set of print functions; and
a quick tab having secondary shortcut tabs that enable customized function organization specific to a print job.

20. The GUI of claim 19 wherein the secondary shortcut tabs comprises:
a first profile button representing a first print profile having a first customized function organization;
a second profile button representing a second print profile having a second customized function organization; and
a profile search bar to enable keyword searching for the first and second print profiles; and
a customize button to initiate generation of a new print profile by entering a customization mode.
